(19) United States
(12) Patent Application Publication
(10) Pub. No.: US 2008/0027801 A1
(43) Pub. Date: Jan. 31, 2008

(54) Method and system for advertisement insertion within an internet protocol television (IPTV) system

(75) Inventors: Edward A. Walter, Boeme, TX (US); Thomas Hinman Adams, San Antonio, TX (US); Jerald Robert Howcroft, Beverly Hills, MI (US)

Correspondence Address: G. Michael Roebuck, PC, FROST BANK BUILDING, 6750 WEST LOOP SOUTH, SUITE 920, BELLAIRE, TX, 77401, US

(73) Assignee: SBC Knowledge Ventures L.P., Reno, NV (US)

(21) Appl. No.: 11/496,684

(22) Filed: Jul. 31, 2006

(51) Int. Cl. G06Q 30/00; H04N 7/10

(52) U.S. Cl. 705/14; 725/32

(57) ABSTRACT

A method and system are disclosed for inserting advertising and content in an internet protocol (IP) network, the method including accepting a request at an IP travel server associated with a travel zone from a traveling client device in the travel zone to receive home advertising content associated with a home zone and receiving the home advertising content from the home server at the IP travel server associated with the travel zone.

### FIELD OF THE DISCLOSURE

The present disclosure relates to the field of advertising on a television system.

### BACKGROUND

Targeted advertising selects an advertisement and sends the advertisement to selected individuals who are targeted to receive the advertisement. Advertisers can potentially save advertising dollars by selecting who will receive their advertisements rather than indiscriminately broadcasting their advertisements to a general population of recipients. Thus, only those individuals selected by an advertiser receive the targeted advertisement in hope that the targeted recipients will be more responsive on a per capita basis than a general broadcast population. Advertisement distributors and providers that enable such an advertising model (e.g. Internet portals, television providers, access network providers) can correspondingly increase their revenue per advertisement impression by providing targeted advertising options for advertisers.

Targeted advertisements have historically been sent to targeted recipients based on geographic areas so that regional advertisers reach only those advertising recipients who are deemed by the advertiser as most likely to be responsive to their advertisements. Targeted advertisements have also been directed to selected demographic sectors of the population so that the targeted advertisement is sent only to those members of a selected demographic sector who are deemed by advertisers to be most likely to be responsive to their advertisements.

### BRIEF DESCRIPTION OF THE DRAWINGS

FIG. 1 is a schematic diagram of an illustrative embodiment of a high level example of an internet protocol television (IPTV) Service Provider Network Architecture;

FIG. 2 is a schematic diagram of an illustrative embodiment of a detailed model of billing and advertising service activation architecture;

FIG. 3 is a schematic diagram of an illustrative embodiment of a breakdown of the ‘Billing Activation Process’, ‘Ad Content ingestion Process’, and ‘Ad Splicing Process’ in relation to the detailed architecture provided in FIG. 2;

FIG. 4 is a schematic diagram of an illustrative embodiment showing a home zone and a travel zone in an IPTV network;

FIG. 5 is a flow chart showing functions performed in an illustrative embodiment;

FIG. 6 is a schematic diagram of a data structure for storing data in an illustrative embodiment; and

FIG. 7 is a diagrammatic representation of a machine in the form of a computer system within which a set of instructions, when executed, may cause the machine to perform any one or more of the methodologies of the illustrative embodiment.

### DETAILED DESCRIPTION

In view of the above, an illustrative embodiment is presented through one or more of its various aspects to provide one or more advantages, such as those noted below. In a particular embodiment a method for inserting advertising content in an internet protocol television (IPTV) system is disclosed. The method includes identifying at an IPTV travel server associated with a travel zone outside of a home zone, a traveling client device in the travel zone to receive home advertising associated with the home zone; receiving the home advertising from the home server at the IPTV travel server associated with the travel zone; and sending the home advertising from the travel server to the traveling client device. In another aspect of a particular embodiment the method further includes multicasting the home advertising from the IPTV travel server to a plurality of traveling client devices in the travel zone when the home content is sent to more than a predetermined threshold number of traveling clients in the travel zone; and unicasting the home advertising from the IPTV travel server to the traveling client device when the home content is sent to less than the predetermined threshold of traveling clients in the travel zone.

In another aspect of a particular embodiment the method further includes locating the home advertising in an advertising server associated with the IPTV home server and receiving at the IPTV travel server, a unicast of the home advertising from the advertising server. In another aspect of a particular embodiment the method further includes sending to the traveling client device, equivalent electronic coupons for an advertiser in the travel zone who is associated with an advertiser in the home zone. In another aspect of a particular embodiment the method further includes adjusting a credit for IPTV service for the traveling client device based upon a quantity of home advertising sent to the traveling client device. In another aspect of a particular embodiment the method further includes monitoring at the traveling IPTV server, advertising content received at the traveling client device to create tracking statistics for traveling clients receiving home advertising and reporting the statistics to the IPTV home server.

In another aspect of a particular embodiment the home advertising includes home advertising includes contact data enabling the traveling client device to seamlessly connect to an advertiser in the travel zone associated with an advertiser in the home zone.

In another particular embodiment a method for receiving advertising in an internet protocol television (IPTV) system is disclosed. The method includes receiving home advertising associated with a home zone at a traveling client device in a travel zone outside of the home zone from an IPTV travel server associated with the travel zone. In another aspect of a particular embodiment the method further includes receiving at the traveling client device, equivalent home electronic coupons for an advertiser in the travel zone who is associated with an advertiser in the home zone.

In another aspect of a particular embodiment the home advertising includes contact data enabling the traveling client device to seamlessly connect to an advertiser in the travel zone associated with an advertiser in the home zone.

In another particular embodiment a system for inserting advertising content in an internet protocol (IP) network is disclosed. The system includes a processor coupled to a memory and a computer program in the memory. The computer program includes instructions to identify at an IP travel server associated with a travel zone outside of a home zone, a traveling client device in the travel zone to receive home advertising associated with the home zone and instructions to receive the home advertising from the home server at the IP travel server associated with the travel zone and instructions to send the home advertising from the travel server to the traveling client device. In another aspect of a particular embodiment the computer program further includes instructions to multicast the home advertising content from the IP travel server to a plurality of traveling client devices in the travel zone when the home content is sent to more than a predetermined threshold number of traveling clients in the travel zone and instructions to unicast the home advertising content from the IP travel server to the traveling client device when the home content is sent to less than the predetermined threshold of traveling clients in the travel zone.

In another aspect of a particular embodiment the computer program further includes instructions to locate the home advertising content in an advertising server associated with the IP home server and instructions to receive at the IP travel server, a unicast of the home advertising from the advertising server. In another aspect of a particular embodiment the computer program further includes instructions to send to the traveling client device, equivalent electronic coupons for an advertiser in the travel zone who is associated with an advertiser in the home zone. In another aspect of a particular embodiment the computer program further includes instructions to adjust a credit for IP service for the traveling client device based upon a quantity of home advertising sent to the traveling client device. In another aspect of a particular embodiment the computer program further includes instructions to monitor at the traveling IP server, home content received at the traveling client device to create tracking statistics for traveling clients receiving home advertising and instructions to report the statistics to the IPTV home server.

In another aspect of a particular embodiment the home advertising content includes contact data enabling the traveling client device to seamlessly connect to an advertiser in the travel zone associated with an advertiser in the home zone.

In another particular embodiment a system for receiving advertising content in an internet protocol (IP) network is disclosed. The system includes a processor coupled to memory and a computer program in the memory comprising instructions to receive home advertising associated with a home zone at a traveling client device in a travel zone outside of the home zone from an IP travel server associated with the travel zone. In another aspect of a particular embodiment the computer program further includes instructions to receive at the traveling client device, the home advertising inserted into content selected from the group consisting of home content and travel content. In another aspect of a particular embodiment the computer program further includes instructions to receive at the traveling client device, equivalent home electronic coupons for an advertiser in the travel zone who is associated with an advertiser in the home zone. In another aspect of a particular embodiment the home advertising content further includes contact data enabling the traveling client device to seamlessly connect to an advertiser in the travel zone associated with an advertiser in the home zone.

In another particular embodiment a computer readable medium contain a computer program for inserting advertising content in an internet protocol (IP) network is disclosed. The computer program includes instructions to identify at an IP travel server associated with a travel zone outside of a home zone, a traveling client device in the travel zone to receive home advertising associated with the home zone, instructions to receive the home advertising from the home server at the IP travel server associated with the travel zone and instructions to sending the home advertising from the travel server to the traveling client device.

In another particular embodiment a computer readable medium containing a computer program for receiving advertising content in an internet protocol (IP) network is disclosed. The computer program includes instructions to receive home advertising associated with a home zone at a traveling client device in a travel zone outside of the home zone from an IP travel server associated with the travel zone, wherein the home advertising is inserted into content selected from the group consisting of home content and travel content

In another particular embodiment a data structure in memory is disclosed. The data structure includes a client ID field for containing data indicating a client device identity; a home zone field for containing data indicating an advertising server for a home zone associated with the client device; and a travel zone field for containing data indicating a travel zone associated with the client device. In another aspect of a particular embodiment the data structure further includes a package identifier field for containing data for indicating an IPTV package for the client device for determining a quantity of advertisements to send to the client device. In another aspect of a particular embodiment the data structure further includes an advertisements received field for storing data indicating which advertisements the client device received in full without switching from the advertisement for creating statistics to send to a home server associated with the home zone. In another aspect of a particular embodiment the data structure further includes a coupon field for storing data indicating coupons and location data indicating locations to which an equivalent home coupon can be provided to the client device in the travel zone. In another aspect of a particular embodiment the data structure further includes a zone server field for storing IPTV server identification data for each travel zone and each home zone indicating an IPTV system server identity associated with each travel zone and each home zone. In another aspect of a particular embodiment the home zone and travel zone fields store data allowing each travel zone and each home zone to be customized according the group consisting of population, density, and areas of interest.

The present disclosure describes a method and system within an IPTV Service Provider Network to insert advertising based upon a home zone and a travel zone defined by a Zip Code, predefined zone, or Demographic Market Area. The home zone and travel zone coverage can be customized by an IPTV subscriber or an IPTV service provider.

An illustrative embodiment enables IPTV service providers the ability to insert home zone advertising content into programmed video content streams in a travel zone. The Central/National Video head-end office (SHO) as defined within this application can be a single office location consisting of satellite and base-band signaling capabilities integrated with processing, switching, encoding, and Video on Demand acquisition facilities. In addition, the Central/National Video head-end office (SHO) streams multicast and unicast packets for the overall IPTV network (i.e., down to the Regional head-end office (VHO) and intermediate office (IO)).

The Regional head-end office (VHO) refers to multiple office locations consisting of off-air antenna equipment with base-band signal processing, switching, encoding, and Video on Demand customer-facing servers. The Regional head-end offices feed multicast and unicast packets to the customer's Set Top Box (STB) in a home zone or to a client device in a home zone. In another particular embodiment local content is provided to a traveling client device through a travel server from a home server in the home zone. The home content contains home advertisements associated with or from the home zone or advertisements. In another particular embodiment the home content is delivered from a home server through a travel server to a traveling client device having advertisements associated with the travel zone inserted into the home content. In another particular embodiment travel content associated with the travel zone is provided to a traveling client with home advertising associated with a home zone inserted into the travel content.

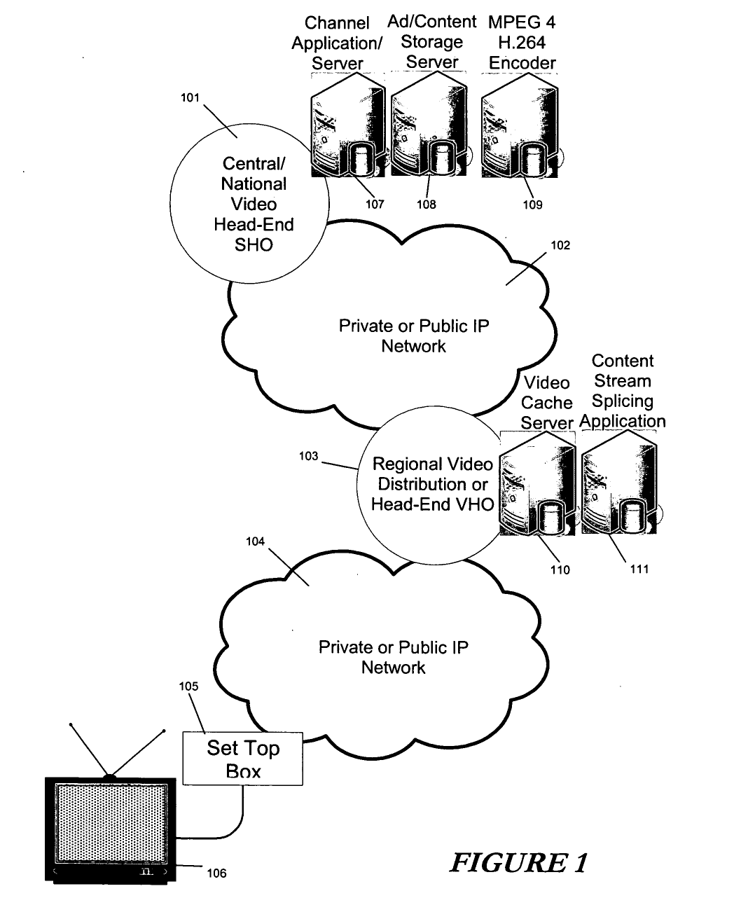

Turning now to FIG. 1, FIG. 1 depicts a high-level architecture of local Advertising insertion distribution from the central/national Video Head-end (SHO) 101 through a Private or Public IP network 102 such as an internet protocol television (IPTV) system via multicast or unicast to multiple Regional Video Head-end offices (VHOs) 103. For the advertising to be spliced it is encoded (e.g., with the H.264) at encoder 109 and passed across to the “Ad/Content Storage” Server 108. From the Ad/Content Storage Server 108 the local or “home” advertising content is spliced via the appropriate application 111 and passed to the Video Cache Server 110 for distribution across a Private or Public IP network 104 via multicast or unicast IP to a consumer's STB 106. The advertising is eventually inserted into a video stream and displayed on the customer's television 106 associated with the IPTV STB or another client device.

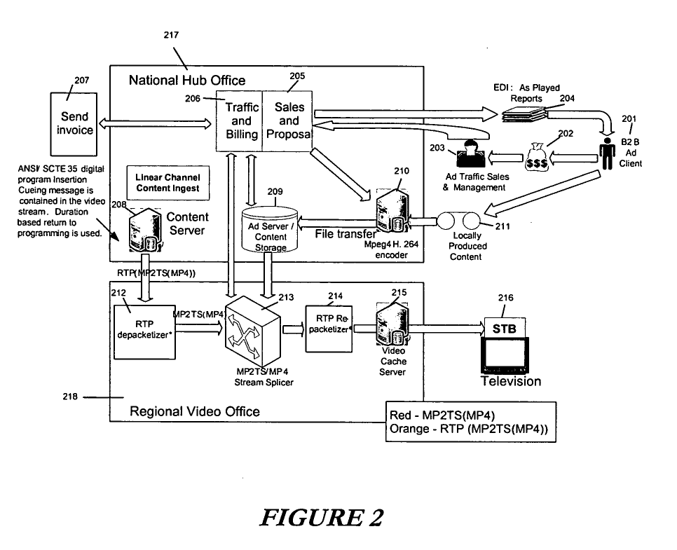

Turning now to FIG. 2, FIG. 2 depicts an IPTV Local Advertising insertion model. The advertising client 201 contacts Service Provider Sales agent to purchase local advertising spot inventory. The advertising client pays 202 service provider to run local advertisements as agreed upon by both parties. The advertising traffic sales and management module 203 uses the traffic and billing system to generate service proposals, make local advertising sales, and enter the sales information into the traffic and billing system. From this the Electronic Data Inter-exchange interface from the Traffic and Billing system to the Ad client to send “As Run/Played” reports 204 showing when the client's ads were actually run. The “Sales and Proposal” system 205 is used by the Ad Traffic Sales and Management personal to generate local advertising proposals and sell spot inventory to the Ad Client. The “Traffic and Billing” system 206 takes the information regarding what was sold in order to schedule the local ad insertions into the live TV programming schedule. The “Traffic and Billing” system sends the invoice to the advertising client 201 for the service provided. The invoice 207 is mailed to the advertising client 201. Note: There may also be other external systems involved with the invoicing if the service provider wants to integrate this billing information with other billing information they are sending to the same client (integrated billing).

In an illustrative embodiment, the local or home advertising 211 is encoded in h.264 210. The local advertising data can be received from the advertising client 201 in tape or electronic form. Live or Programmed TV content is ingested into the Content Server 208 and includes the cue tone information used to tell the Advertising server 209/Splice Equipment 213 when to insert the advertising. The “Traffic and Billing” system 206 sends the Ad Insertion schedule to the Ad Server(s) 209. The “Traffic and Billing” system 206 received information from the Ad servers 206 regarding the actual completion of the Ad Insertions. The RTP header is removed from the linear programming (live TV) content packet via the “RTP De-Packetizer” 212. The moving pictures experts group 4, mpeg4/h.264 live TV content is sent on its way to the consumers TV/Set Top Box for viewing with the original commercial still in tact. The local Advertising Insertion Stream Splicer 213 splices in the home advertising over the original advertising when the cue tone indicates. After splicing the RTP header is added back onto the packet via a “Re-Packetization” process 214. The Video Cache server 215 caches the linear video content for distribution to the customer's home for viewing on their TV via their Set Top Box 216.

The National Hub Office 217 (SHO) can be a single office location that consists of satellite acquisition, receive capabilities, base-band signal processing/switching/redundancy, encoding, and VoD acquisition/ingest facilities. This location provides all linear stream multicast signals and unicast VoD for the entire IPTV network. The Regional Hub Offices 218 are multiple office locations consist of off-air antenna and receive equipment, base-band signal processing/switching/redundancy, encoding, and VoD customer facing servers. The regional hub offices provide all off-air local multicast signals (joined with linear regional hub office signals).

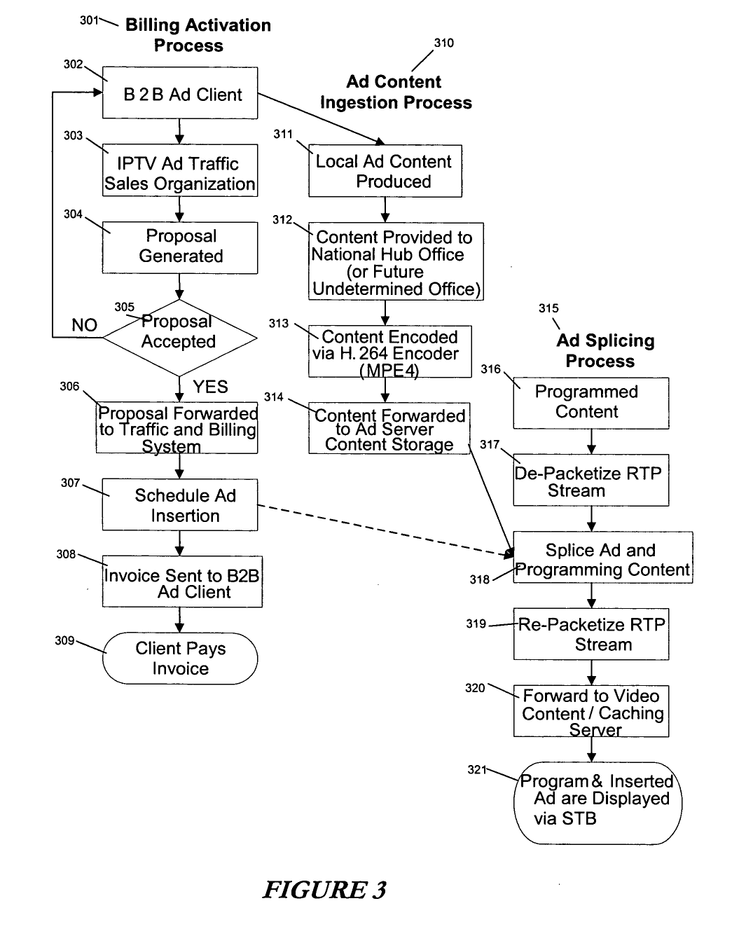

Turning now to FIG. 3, FIG. 3 illustrates the process of Billing activation, advertising content ingestion, and ad splicing of content into the main programming content stream. These steps are further defined by the sub-components in FIG. 2. As part of the Billing Activation process 301 the Ad Client 302, 201 request advertising time from the IPTV Service provider. This request is funneled to the IPTV Advertising Traffic Sales Organization 303, 203 or a similar functioning support organization. This organization then generates a proposal 304 which is forwarded to the customer 302, 201. The advertising client can either accept the terms or renegotiate 305. If the proposal is accepted then the advertising information is forwarded onto the “Traffic and Billing” system 306, 206. Splice Information is passed from the “Traffic and Billing” system 307, 206 to the “Advertising Server” 209. In addition, an invoice 207 is generated and sent to the advertising client 308. The final step in the Billing component is customer pays invoice 309.

In addition to requesting time the advertising client 302 provides the local ad content 311, 211 via electronic or tape media. The content is provided at the National Hub Office level 312, 217 to be encoded 313, 210. Once encoded via H.264 the content is passed to the “Advertising Server” 314, 209.

The process of splicing programming content with advertising content is depicted at block 315. Programming content is organized 316, 208 at the Content Server. The programming content is “De-packetized” 317, 212 and forwarded to the “Stream Splicer” 318, 213. At this point the home advertising content is inserted into the programming stream based upon cue tones. The spliced stream is then “Re-Packetized” 319, 214 and forwarded onto the “Video Cache” Server 320, 215. The final destination of the spiced content in the STB 321, 216 for display on the customer's television 106.

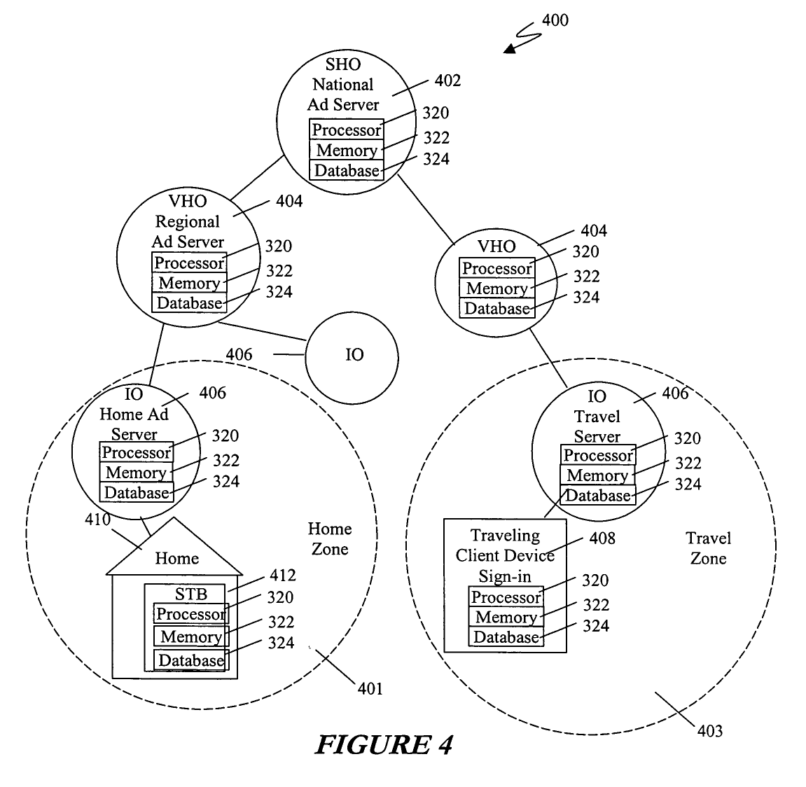

Turning now to FIG. 4 in an illustrative embodiment a home zone 401 associated with a home advertising server 406 and a travel zone 403 associated with a traveling client device and travel server 406 are illustrated. In an illustrative embodiment a traveling client device 408 in a travel zone 403 issues a request to a travel server 406 to receive home advertising from the home advertising server 406 in the home zone 401. The home advertising server can be associated with the home location for a particular client and may be located in either an intermediate office (IO) 406, a VHO regional server 404 or a national server SHO 402. Thus the advertising server may be located in either, the SHO, VHO or IO and contain home advertising content related to a registration address for set top box in an IPTV system. Home advertising server 406 may be distributed logically and/or physically between the IO, VHO and SHO and may contain national, regional and local advertisements which are destined for residents in a home zone 401 or for traveling client devices in a travel zone. When a traveling client device sign-in 408 signs in to a travel server 406 the identity of the traveling client is tied back to an IPTV system subscriber database 324 in an IPTV server (SHO, VHO or IO) and identifies the traveling client by a log-on ID or MAC address for a client device utilized in signing on to the IPTV system. This identity for the traveling client is tied to an IPTV registration database 324 which can be kept in the SHO, VHO or IO. The registration database includes profiles for a subscriber such as the home address or registration address for the set top box in home 410. As shown in FIG. 4 each set top box, IO, VHO and SHO and traveling client include a processor 320, memory 322, and database 324.

When a request is received from a traveling client at a travel server the IPTV system searches for a home advertising server containing advertisements associated with the traveling client device's registered home address. These home advertisements are collected and served from the home advertising server to the traveling server in unicast. If more than a predetermined threshold number of traveling client devices has requested the same home advertising server content through the same travel server then the home advertising server content is multicast to a multiplicity of traveling client devices who requested home advertising from a particular travel server 406. Likewise if a plurality of travel servers are served by a particular VHO and are requesting the same home advertising content then the home advertising content can be unicast from the home advertising server located at either the IO, VHO or SHO to the travel server(s) associated with the traveling client devices. The requesting home servers may then unicast or multicast the home advertising content to the requesting traveling client devices. The home advertising content is multicast from a travel server whenever a predetermined threshold number of traveling client devices, for example, two traveling client devices have requested the same home advertising content in the same travel zone. The predetermined threshold can be selected based on network load conditions and available bandwidth or other conditions selected by the IPTV service provider.

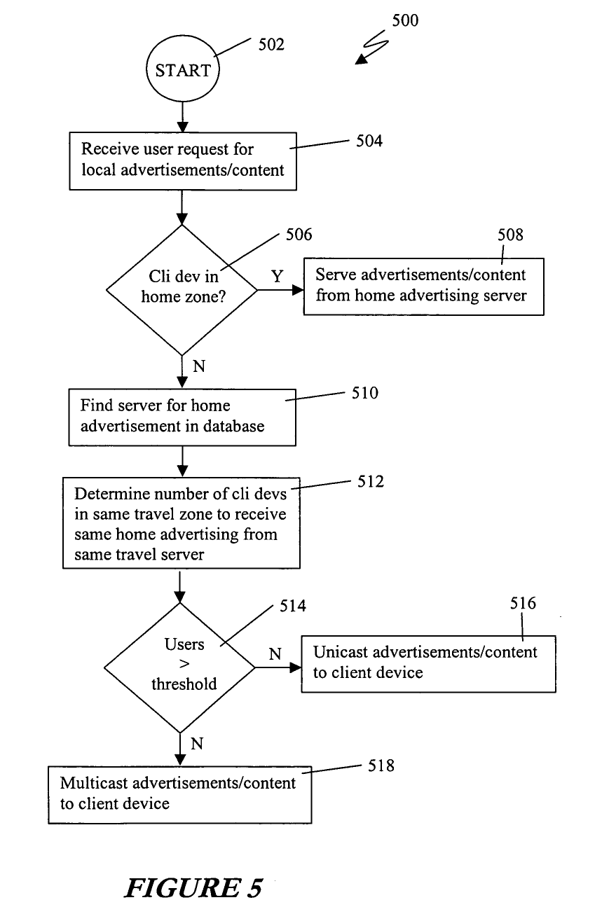

Turning now to FIG. 5 a flow chart of functions is illustrated showing functions performed in an illustrative embodiment. At 502 the process starts and at 504 the illustrative embodiment receives a user request for home advertisement and content. At 506 a function determines if the client device is in its home zone. If the client device is in the home zone at 508 the process serves advertisements and content from the home advertising server to the client in the home zone. If the client device is not in the home zone then the process finds a server in the IPTV system containing the home advertisement content in its database at block 510. At block 512 the process determines the number of client devices in the same travel zone who are to receive the same or overlapping home advertising content from the same travel server. The location of the home advertising content can be stored in the database at the SHO, VHO or IO. At block 514 if the number of client devices in block 512 exceeds a predetermined threshold, for example one, then the home advertising content is multicast to the client devices in the travel zone requesting the home advertising content. If the number of users in block 512 is less than or equal to the threshold then the home advertising content is unicast to the client devices requesting the home advertising content.

The home advertising content is unicast to the server and inserted in content where national or other local advertising would normally be inserted. The home advertising content can be spliced in at a travel server or fed directly to a traveling client device and inserted from the client device. In either case a home advertising content can be inserted into a video stream at the client device in a travel zone.

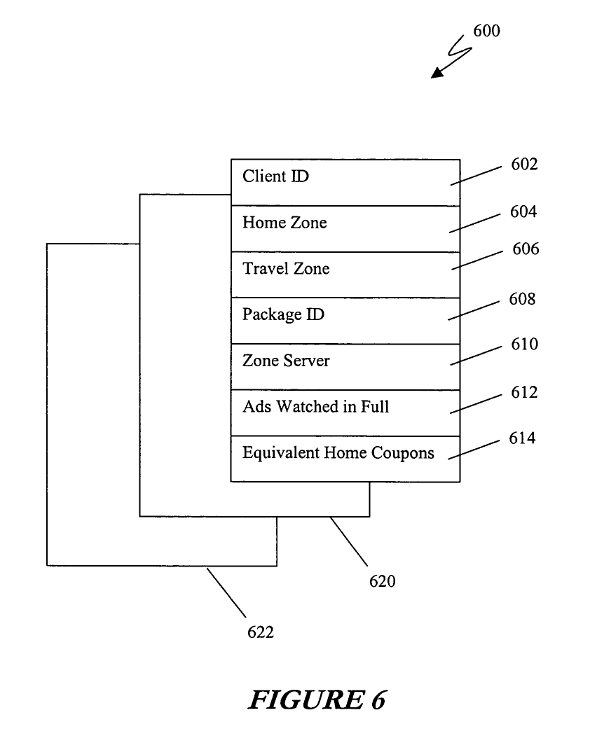

Turning now to FIG. 6 a data structure utilized in an illustrative embodiment is depicted. As shown in FIG. 6 the data structure 600 contains a client ID field 602, a home zone field 604, a travel zone field 606, package ID field 608, a zone server field 610, ads watched in full field 612 and equivalent home coupons field 614. Multiple data structures for multiple different client devices 620 and 622 may also be stored in memory for correlating between or matching client ID having the same home zone and the same travel zone for delivering content to the client devices identified by the client ID while traveling. The client ID field contains data indicating a client device identity. The home zone field contains data indicating an advertising server for a home zone associated with the client device. The travel zone field contains data indicating a travel zone associated with the client device.

The package identifier field contains data for indicating an IPTV package for the client device for determining a quantity of advertisements to send to the client device. Different levels of advertising can be sent. A credit toward the purchase of IPTV service is adjusted for advertisements watched by a user at a client device. The more advertisements a client device receives and watches in full, the more credit it receives toward pay for IPTV service. An advertisement is deemed watched in full when a client device receives the advertisement inserted into content without switching to another IP address during reception of the advertisement. The switching/not switching during advertisements is monitored by the client device or the travel server and stored in the data structure. The advertisements received field stores data indicating which advertisements the client device has received in full without switching from the advertisement for creating statistics to send to a home server associated with the home zone.

The coupon field stores data indicating coupons and location data indicating locations to which an equivalent home coupon can be provided to the client device in the travel zone. The zone server field stores IPTV server identification data for each travel zone and each home zone indicating an IPTV system server identity associated with each travel zone and each home zone. The home zone and travel zone fields store data allowing each travel zone and each home zone to be customized for example, including but not limited to, population density, demographic area, zip code, density, and geographical areas of interest.

In an illustrative embodiment equivalent home coupons can be sent to a client device while traveling in a travel zone. Home advertisers can make associations with similar or equivalent advertisers in a travel zone. A home zone advertiser can send a coupon that's redeemable at an equivalent store in the travel zone. Thus a coupon for an advertiser in a home zone who has a similar store in the travel zone may send a coupon to the client device in the travel zone that is good at the advertiser's store in the travel zone. In another particular illustrative embodiment when a home advertiser does not have a store in the travel zone the home advertiser may identify equivalent advertisers offering a similar product or service in the travel zone and provide a coupon for that equivalent product or service in the travel zone to the client device in the travel zone. Home zone advertisers and equivalent travel zone advertisers can exchange referral credits or fees for equivalent coupons sent by home advertisers to traveling client devices and used at equivalent advertisers in a travel zone.

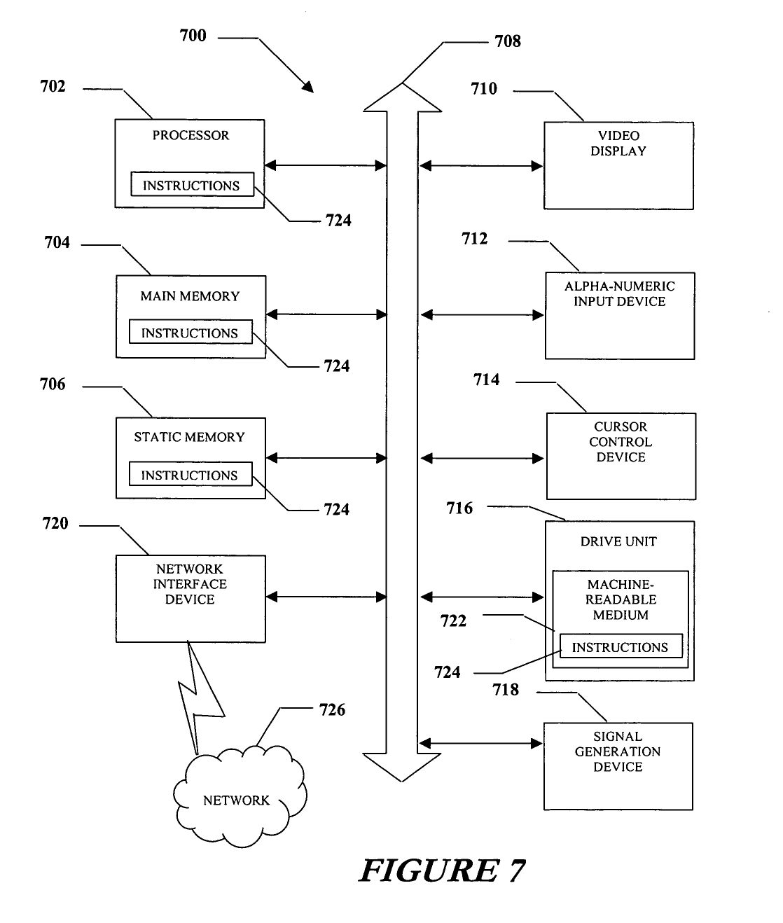

Turning now to FIG. 7, the computer system 700 may include a processor 702 (e.g., a central processing unit (CPU), a graphics processing unit (GPU), or both), a main memory 704 and a static memory 706, which communicate with each other via a bus 708. The computer system 700 may further include a video display unit 710 (e.g., liquid crystals display (LCD), a flat panel, a solid state display, or a cathode ray tube (CRT)). The computer system 700 may include an input device 712 (e.g., a keyboard), a cursor control device 714 (e.g., a mouse), a disk drive unit 716, a signal generation device 718 (e.g., a speaker or remote control) and a network interface device 720.

The disk drive unit 716 may include a machine-readable medium 722 on which is stored one or more sets of instructions (e.g., software 724) embodying any one or more of the methodologies or functions described herein, including those methods illustrated in herein above. The instructions 724 may also reside, completely or at least partially, within the main memory 704, the static memory 706, and/or within the processor 702 during execution thereof by the computer system 700. The main memory 704 and the processor 702 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the illustrative embodiment, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The illustrative embodiment contemplates a machine readable medium containing instructions 724, or that which receives and executes instructions 724 from a propagated signal so that a device connected to a network environment 726 can send or receive voice, video or data, and to communicate over the network 726 using the instructions 724. The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the illustrative embodiment. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the illustrative embodiment is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the illustrative embodiment is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

What is claimed is:

1. A method for inserting advertising content in an internet protocol television (IPTV) system comprising:
identifying at an IPTV travel server associated with a travel zone outside of a home zone, a traveling client device in the travel zone to receive home advertising associated with the home zone;
receiving the home advertising from the home server at the IPTV travel server associated with the travel zone; and
sending the home advertising from the travel server to the traveling client device.

2. The method of claim 1, further comprising:
multicasting the home advertising from the IPTV travel server to a plurality of traveling client devices in the travel zone when the home content is sent to more than a predetermined threshold number of traveling clients in the travel zone; and
unicasting the home advertising from the IPTV travel server to the traveling client device when the home content is sent to less than the predetermined threshold of traveling clients in the travel zone.

3. The method of claim 1, the method further comprises:
locating the home advertising in an advertising server associated with the IPTV home server; and
receiving at the IPTV travel server, a unicast of the home advertising from the advertising server.

4. The method of claim 1, further comprising:
sending to the traveling client device, equivalent electronic coupons for an advertiser in the travel zone who is associated with an advertiser in the home zone.

5. The method according to claim 1, further comprising:
adjusting a credit for IPTV service for the traveling client device based upon a quantity of home advertising sent to the traveling client device.

6. The method of claim 1, further comprising:
monitoring at the traveling IPTV server, advertising content received at the traveling client device to create tracking statistics for traveling clients receiving home advertising; and
reporting the statistics to the IPTV home server.

7. The method according to claim 1, wherein the home advertising includes contact data enabling the traveling client device to seamlessly connect to an advertiser in the travel zone associated with an advertiser in the home zone.

8. A method for receiving advertising in an internet protocol television (IPTV) system comprising:
receiving home advertising associated with a home zone at a traveling client device in a travel zone outside of the home zone from an IPTV travel server associated with the travel zone.

9. The method of claim 8, further comprising:
receiving at the traveling client device, equivalent home electronic coupons for an advertiser in the travel zone who is associated with an advertiser in the home zone.

10. The method according to claim 8, wherein the home advertising includes contact data enabling the traveling client device to seamlessly connect to an advertiser in the travel zone associated with an advertiser in the home zone.

11. A system for inserting advertising content in an internet protocol (IP) network, the system comprising:
a processor coupled to a memory; and
a computer program in the memory, the computer program comprising instructions to identify at an IP travel server associated with a travel zone outside of a home zone, a traveling client device in the travel zone to receive home advertising associated with the home zone and instructions to receive the home advertising from the home server at the IP travel server associated with the travel zone and instructions to send the home advertising from the travel server to the traveling client device.

12. The system of claim 11, the computer program further comprising:
instructions to multicast the home advertising content from the IP travel server to a plurality of traveling client devices in the travel zone when the home content is sent to more than a predetermined threshold number of traveling clients in the travel zone and instructions to unicast the home advertising content from the IP travel server to the traveling client device when the home content is sent to less than the predetermined threshold of traveling clients in the travel zone.

13. The system of claim 11, the computer program further comprising:
instructions to locate the home advertising content in an advertising server associated with the IP home server and instructions to receive at the IP travel server, a unicast of the home advertising from the advertising server.

14. The system of claim 11, the computer program further comprising:
instructions to send to the traveling client device, equivalent electronic coupons for an advertiser in the travel zone who is associated with an advertiser in the home zone.

15. The system of claim 11, the computer program further comprising:
instructions to adjust a credit for IP service for the traveling client device based upon a quantity of home advertising sent to the traveling client device.

16. The system of claim 11, the computer program further comprising instructions to monitor at the traveling IP server, home content received at the traveling client device to create tracking statistics for traveling clients receiving home advertising and instructions to report the statistics to the IPTV home server.

17. The system of claim 11, wherein the home advertising content includes contact data enabling the traveling client device to seamlessly connect to an advertiser in the travel zone associated with an advertiser in the home zone.

18. A system for receiving advertising content in an internet protocol (IP) network system comprising:
a processor coupled to memory; and
a computer program in the memory comprising instructions to receive home advertising associated with a home zone at a traveling client device in a travel zone outside of the home zone from an IP travel server associated with the travel zone.

19. The system of claim 18, the computer program further comprising:
instructions to receive at the traveling client device, the home advertising inserted into content selected from the group consisting of home content and travel content.

20. The system of claim 18, the computer program further comprising:
instructions to receive at the traveling client device, equivalent home electronic coupons for an advertiser in the travel zone who is associated with an advertiser in the home zone.

21. The system of claim 18, wherein the home advertising content further comprises:
contact data enabling the traveling client device to seamlessly connect to an advertiser in the travel zone associated with an advertiser in the home zone.

22. A computer readable medium contain a computer program for inserting advertising content in an internet protocol (IP) network, the computer program comprising:
instructions to identify at an IP travel server associated with a travel zone outside of a home zone, a traveling client device in the travel zone to receive home advertising associated with the home zone, instructions to receive the home advertising from the home server at the IP travel server associated with the travel zone and instructions to sending the home advertising from the travel server to the traveling client device.

23. A computer readable medium containing a computer program for receiving advertising content in an internet protocol (IP) network, the computer program comprising:
instructions to receive home advertising associated with a home zone at a traveling client device in a travel zone outside of the home zone from an IP travel server associated with the travel zone, wherein the home advertising is inserted into content selected from the group consisting of home content and travel content.

24. A data structure in memory, comprising:
a client ID field for containing data indicating a client device identity;
a home zone field for containing data indicating an advertising server for a home zone associated with the client device; and
a travel zone field for containing data indicating a travel zone associated with the client device.

25. The data structure of claim 24, further comprising:
a package identifier field for containing data for indicating an IPTV package for the client device for determining a quantity of advertisements to send to the client device.

26. The data structure of claim 24, further comprising:
an advertisements received field for storing data indicating which advertisements the client device received in full without switching from the advertisement for creating statistics to send to a home server associated with the home zone.

27. The data structure of claim 24, further comprising:
a coupon field for storing data indicating coupons and location data indicating locations to which an equivalent home coupon can be provided to the client device in the travel zone.

28. The data structure of claim 24, further comprising a zone server field for storing IPTV server identification data for each travel zone and each home zone indicating an IPTV system server identity associated with each travel zone and each home zone.

29. The data structure of claim 24, wherein the home zone and travel zone fields store data allowing each travel zone and each home zone to be customized according the group consisting of population, density, and areas of interest.
